(19) United States
(12) Patent Application Publication
(10) Pub. No.: US 2026/0254360 A1
(43) Pub. Date: Aug. 27, 2026

(54) METHODS FOR OPERATING A POWER CONVERTER, CONTROLLER FOR A POWER CONVERTER, AND POWER CONVERTER

(71) Applicant: Infineon Technologies Austria AG, Villach (AT)

(72) Inventors: Marcus SCHÄMANN, Taufkirchen (DE); Junyang LUO, Singapore (SG); Lukas LOHAUS, Essen (DE); Mingping MAO, Singapore (SG); Zhidan LUO, Singapore (SG); Frank SIMMER, Solingen (DE); Thomas DUDA, Duisburg (DE); Siu Kam KOK, Singapor (SG)

(21) Appl. No.: 19/538,243

(22) Filed: Feb. 12, 2026

(30) Foreign Application Priority Data
Feb. 24, 2025 (DE) 102025106952.2

(51) Int. Cl. H02M 3/335

(52) U.S. Cl. CPC H02M 3/33576

(57) ABSTRACT

This disclosure includes a method in which the timing of closure of a secondary-side switch is set based on a difference in a voltage at a node between a first time prior to closure of a primary-side switch and a second time while the primary-side switch is closed. This disclosure also provides other methods, and also controllers and power converters.

### RELATED APPLICATION

This application claims priority to earlier filed German Patent Application Serial Number 10 2025 106 952.2, entitled “METHODS FOR OPERATING A POWER CONVERTER, CONTROLLER FOR A POWER CONVERTER, AND POWER CONVERTER,” (Attorney Docket No. 42193DE), filed on Feb. 24, 2025, the entire teachings of which are incorporated herein by this reference.

### TECHNICAL FIELD

The present application relates to methods for operating a power converter, corresponding controllers for power converters, and power converters.

### BACKGROUND

Power converters are generally used to convert an electrical input power into an electrical output power. Power converters may be for example voltage converters that convert an input voltage, for example a mains voltage or an intermediate voltage generated by a previous stage, into an output voltage (which may in turn serve as input voltage for another stage), or current converters that convert an input current into a desired regulated output current.

Some power converters, for example flyback converters, have galvanic isolation between the input side, also referred to as the primary side, and the output side, also referred to as the secondary side. A transformer is used for this purpose. Power is supplied to a primary-side winding of the transformer in a manner controlled by a primary-side switch, transmitted to the secondary-side winding of the transformer, and output as output power in rectified form. Characteristics of the output power, such as for example the output voltage, may then be regulated in particular through appropriate control of the primary-side switch. The use of “a” primary-side switch in this application also includes cases in which multiple primary-side switches are used, for example in a bridge or half-bridge configuration.

To regulate characteristics of the output power, provision is often likewise made for an isolation barrier, for example via an optocoupler or a capacitor, in order to maintain the galvanic isolation. A secondary-side controller measures parameters, for example a reflected input voltage and/or the output voltage, and transmits appropriate information as to how the primary-side switch should be driven to the primary side. Such a control loop has a delay. This makes it difficult to measure the parameters on the secondary side at optimum times.

Synchronous rectification (SR) is used in many implementations to achieve rectification on the secondary side. In this case, to achieve rectification, a secondary-side switch is controlled in a certain timing relationship, that is to say synchronously, in relation to the primary-side switch. This control may also be imprecise due to the abovementioned delays.

Such a secondary-side switch may also be used, in addition or as an alternative, to transmit a pulse from the secondary side to the primary side in order to enable zero-voltage switching (ZVS), as it is known. For this purpose, the secondary-side switch is briefly switched on before the primary-side switch is switched on, in order to ensure that there is essentially no voltage or only a small voltage across the primary-side switch during the switching operation. The length of this brief switch-on affects whether zero-voltage switching is achieved and/or power losses occur.

### SUMMARY

According to a first aspect, provision is made for a method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output. The method in this case comprises:
Obtaining a measurement that characterizes a difference between a voltage at a node between the terminal of the secondary-side winding and the secondary-side switch at a first time prior to closure of the primary-side switch and a second time at which the primary-side switch is closed, and
Adjusting the timing of the closure of the secondary-side switch based on the measurement.

According to a second aspect, provision is made for a method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output. The method in this case comprises:
Measuring a current from a node between the terminal of the secondary-side winding and the secondary-side switch, and
Adjusting a time of closure of the secondary-side switch in order to implement a synchronous rectification functionality based on the measurement.

According to a third aspect, provision is made for a method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output. The method in this case comprises:
Obtaining a first measurement that characterizes a voltage at a node between the terminal of the secondary-side winding and the secondary-side switch,
Performing a second measurement of a reflected input voltage on the secondary side while the first measurement indicates that the voltage is above a threshold value.

According to further aspects, provision is made for a controller for a power converter as described above, configured to control the power converter so as to perform the abovementioned methods, in particular to perform the abovementioned measurements and to control the secondary-side switch.

Finally, provision is made for a power converter comprising a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output, and a controller as described above.

### BRIEF DESCRIPTION OF THE FIGURES

FIG. 1 is a diagram of a power converter according to one embodiment.

FIG. 2 is a flowchart of a method according to one embodiment.

FIG. 3 is a flowchart of a method according to a further embodiment.

FIG. 4 is a flowchart of a method according to a further embodiment.

FIG. 5 is a diagram of a power converter of one embodiment.

FIGS. 6A-6C and 7 are signal diagrams for illustrating various embodiments.

FIG. 8 is a block diagram of a secondary-side controller according to one embodiment.

FIGS. 9, 10, 11A-11C and 12 are signal diagrams for illustrating various embodiments.

FIG. 13 is a block diagram of a secondary-side controller according to one embodiment.

FIG. 14 is a block diagram of a secondary-side controller according to one embodiment.

FIG. 15 is a signal diagram for illustrating the embodiments of FIGS. 13 and 14.

### DETAILED DESCRIPTION

Various embodiments will be described in more detail below with reference to the appended drawings. These embodiments serve only illustrative purposes and should not be interpreted as restrictive.

Features (for example components, method steps, etc.) described for one embodiment may also be applied to other embodiments, unless explained otherwise. In particular, details or variations described for one embodiment are not discussed multiple times, but may generally be applied to different embodiments.

The same or corresponding features in the figures bear the same reference signs and are not explained repeatedly.

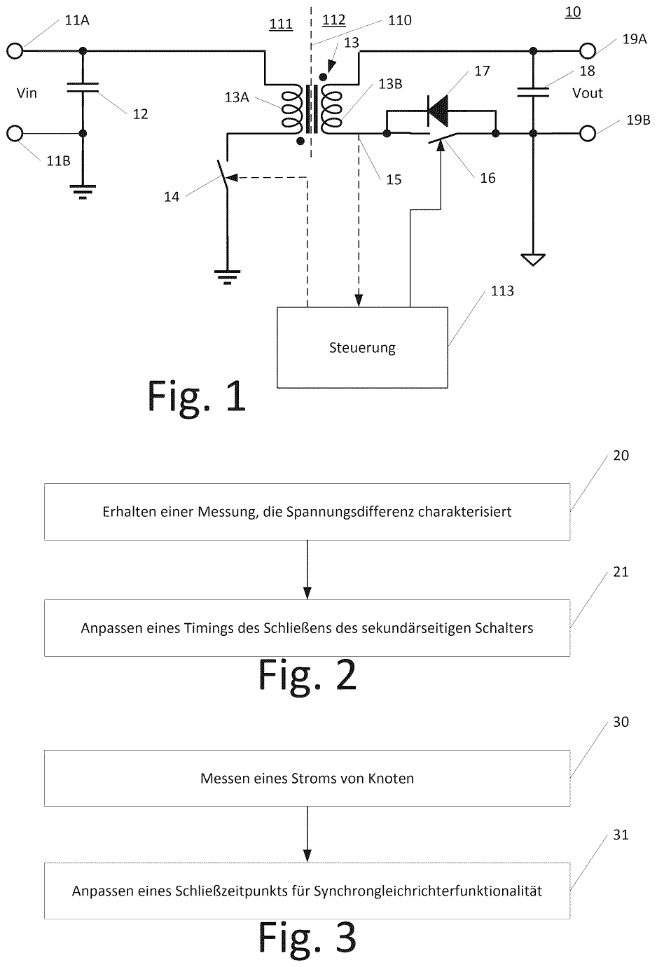

FIG. 1 shows a power converter 10 according to one embodiment, having a controller 113 according to one embodiment. The controller 113 is in this case configured in particular to control the power converter 10 so as to perform one of the methods described in more detail below.

The power converter 10 receives an input voltage Vin at input terminals 11A, 11B and outputs an output voltage Vout at output terminals 19A, 19B. The input voltage is buffered by an input capacitor 12, which may also be omitted in other embodiments or be replaced by another type of input stage. A primary-side switch 14 is used to selectively close a circuit through a primary-side winding 13A of a transformer 13, that is to say, when the switch 14 is closed, the voltage Vin is present at the primary-side winding 13A and may cause a corresponding current flow.

The transformer 13 separates a primary side 111 of the power converter 10 from a secondary side 112. The separation is indicated by a dashed line 110.

By selectively opening and closing the primary-side switch 14, energy is transferred in controlled fashion to a secondary-side winding 13B of the transformer 13. This first gives rise to an AC voltage, which is rectified by way of a synchronous rectification switch 16, buffered by an output capacitor 18 and then output as output voltage Vout. The synchronous rectification switch 16 may be implemented for example by a transistor having a body diode, or provision may additionally be made for a corresponding diode 17.

The controller 113 may obtain information about the output voltage Vout and/or an input voltage reflected to the secondary side, and in response cause the switch 14 to be driven so as to regulate the output voltage Vout to a desired value. In addition, the controller 113 drives the synchronous rectification switch 16 so as to achieve rectification.

The transformer 13 provides galvanic isolation between the primary side and the secondary side. In order not to violate this galvanic isolation, the controller 113, as will be explained later, may contain a secondary-side controller and a primary-side controller, which communicate with one another and are likewise galvanically decoupled, for example via an optocoupler, a capacitor by way of capacitive coupling or by a transformer by way of inductive coupling. The communication by way of capacitive or inductive coupling may also in this case be integrated into the housing of an integrated circuit (IC).

In addition to synchronous rectification, the secondary-side switch 16 may also be used to cause zero-voltage switching (ZVS) of the primary-side switch. For this purpose, the secondary-side switch 16 is briefly closed prior to closure of the primary-side switch 14, in order to transmit a pulse from the secondary side 112 to the primary side 111.

The basic regulation of a flyback converter, like the power converter 10 of FIG. 1, achieved by driving the primary-side switch 14 and the secondary-side switch 16, may in this case be carried out in the same way as in the case of conventional converters in terms of timing, aside from the special features explained below.

Switches such as the primary-side switch 14 and the secondary-side switch 16 may be implemented in the form of transistors, for example field-effect transistors, bipolar transistors or insulated-gate bipolar transistors (IGBTs). A switch is closed, or on, when it provides a conductive connection between its terminals, and is open, or off, when it substantially (with the exception of any leakage currents) provides electrical isolation between its terminals.

The controller 113 is configured, in various embodiments, to perform timing of the closure of the secondary-side switch 16, for example to achieve rectification or to cause zero-voltage switching, based on measurements at a node 15 between a terminal of the secondary-side winding 13B and the switch 16. Such a measurement may also be taken as a basis for performing a time of measurement of a reflected input voltage on the secondary side. Such techniques will now be explained in more detail.

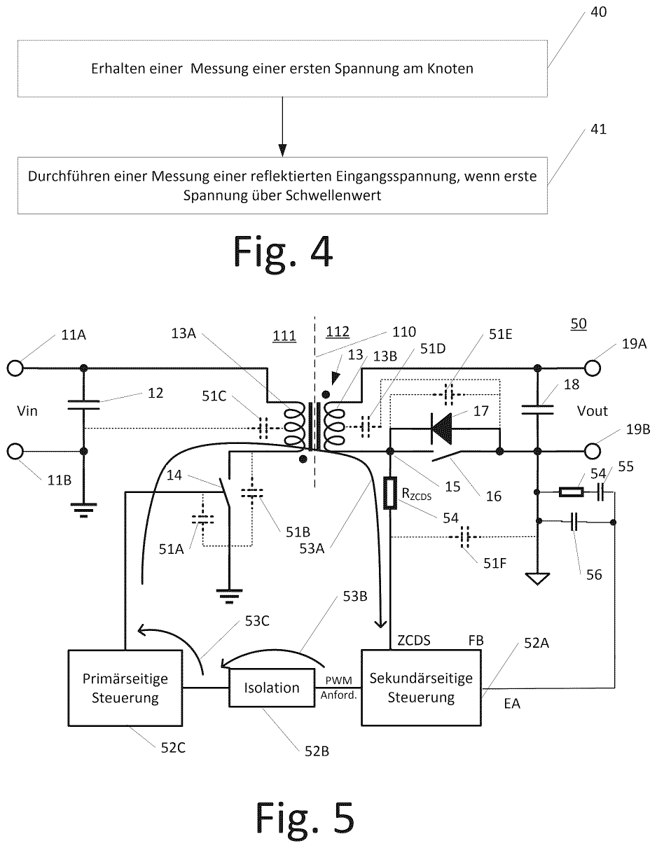

FIGS. 2-4 show various methods according to embodiments that may be implemented for example by way of the controller 113 in the power converter 10 of FIG. 1 or other such power converters having a primary-side switch, a transformer and a secondary-side switch. In this respect, the power converter 10 should be understood only as an example, and other power converters with configurations having one (or more) primary-side switch(es), a transformer and a secondary-side switch may likewise be used.

The methods of FIGS. 2-4 may be implemented together, but also individually or else in different combinations, that is to say only two of the methods, in various embodiments of methods, controllers and power converters.

The method of FIG. 2 relates to adjusting the timing of the secondary-side switch. At 20, a measurement is obtained, characterizing a voltage difference at a node such as the node 15, that is to say a node between a terminal of the secondary-side winding and a terminal of the secondary-side switch, at two different times. The first time is in this case before, in particular shortly before, closure of the primary-side switch, and the second time is at a time at which the primary-side switch is closed. The time shortly before the closure of the primary-side switch may in this case be a time at the end of a so-called ZVS dead time, a period in which the secondary-side switch 16 is opened after a first closure period so as to cause zero-voltage switching and before a second closure period so as to achieve synchronous rectification. Such a measurement that characterizes this voltage difference may for example be obtained directly by measuring the respective voltages at the times. However, as will be explained in more detail later, it may also be obtained indirectly by comparing a current from the node (for example node 15) with a current threshold value.

At 21, the method of FIG. 2 then comprises adjusting the timing of the closure of the secondary-side switch based on the measurement. In particular, it is possible to adjust a duration of closure of the secondary-side switch so as to generate zero-voltage switching on the primary side, that is to say a duration of the first closure period explained above, on the basis of the measurement. As will be explained later, for example, a best-optimized length of this closure of the secondary-side switch is achieved if the first voltage at the first time is just below the second voltage at the second time (for example between 95% and 100% of the second voltage) or if it is approximately the same.

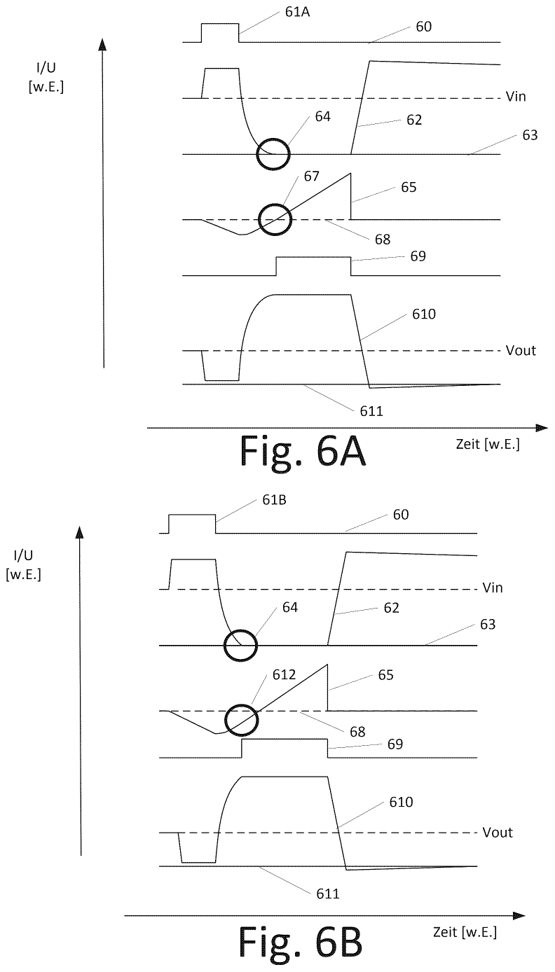

FIG. 3 shows a further method able to be implemented by way of the controller 113. At 30, a current from said node, for example node 15, is measured. At 31, a closure time of the secondary-side switch for the synchronous rectification functionality is adjusted on the basis of the measurement. This will also be explained in more detail below.

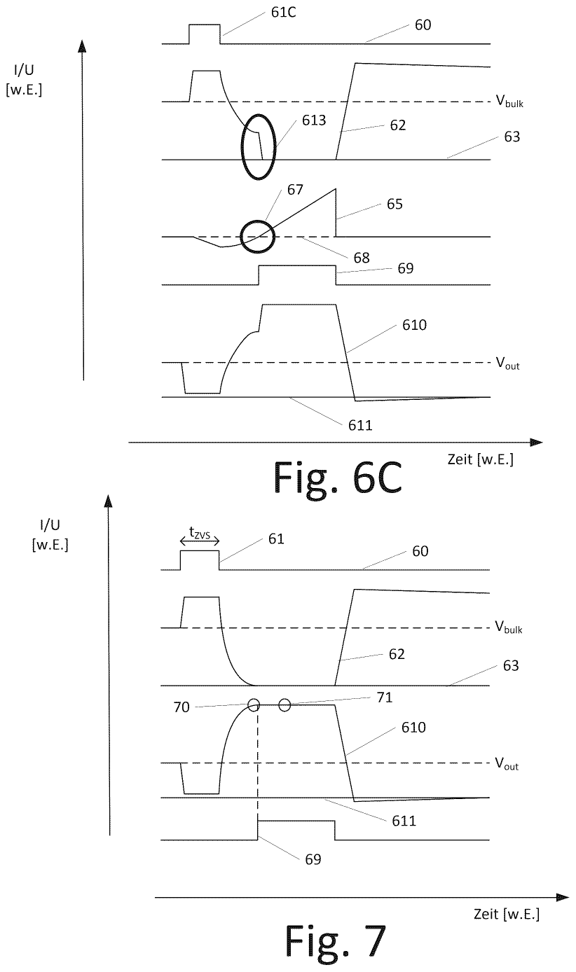

FIG. 4 shows a further method according to a further exemplary embodiment. At 40, a measurement is obtained, characterizing a first voltage at said node, for example node 15 of FIG. 1. At 41, a reflected input voltage is measured when the measurement indicates that the first voltage exceeds a threshold value, in particular as soon as the first voltage is above the threshold value. The reflected input voltage arises on the secondary side when the primary-side switch is closed and the input voltage Vin is present on the primary side of the transformer. The turns ratio reflects this input voltage from the primary side to the secondary side. In the case of a turns number Np on the primary side and Ns on the secondary side, the reflected input voltage Vin, sec on the secondary side is thus Vin, sec=Vin/Np*Ns.

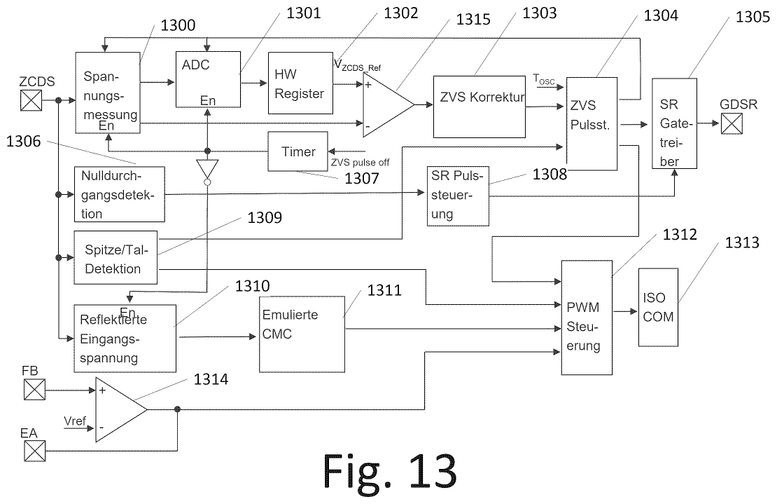

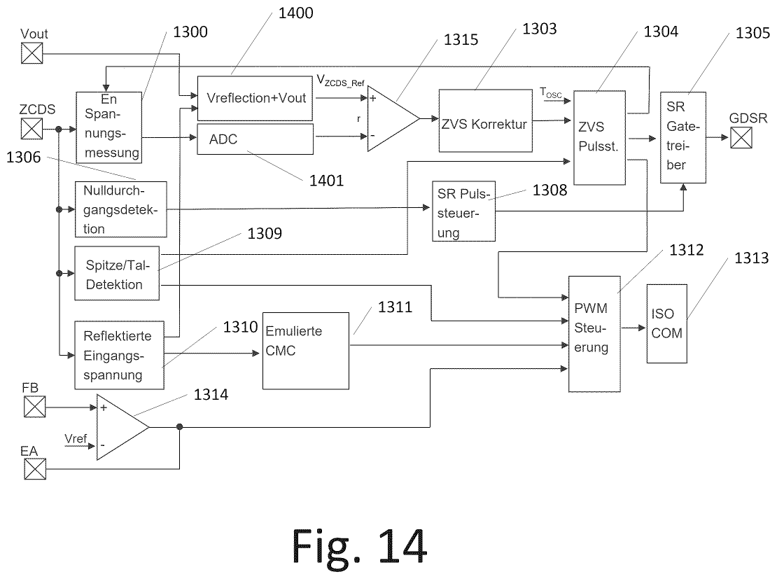

The measurement of the reflected input voltage on the secondary side is a conventional regulation process in and of itself, which will also be briefly explained below with reference to FIGS. 13 and 14. A time of this measurement is able to be optimized using the method of FIG. 4. This will also be explained in more detail below.

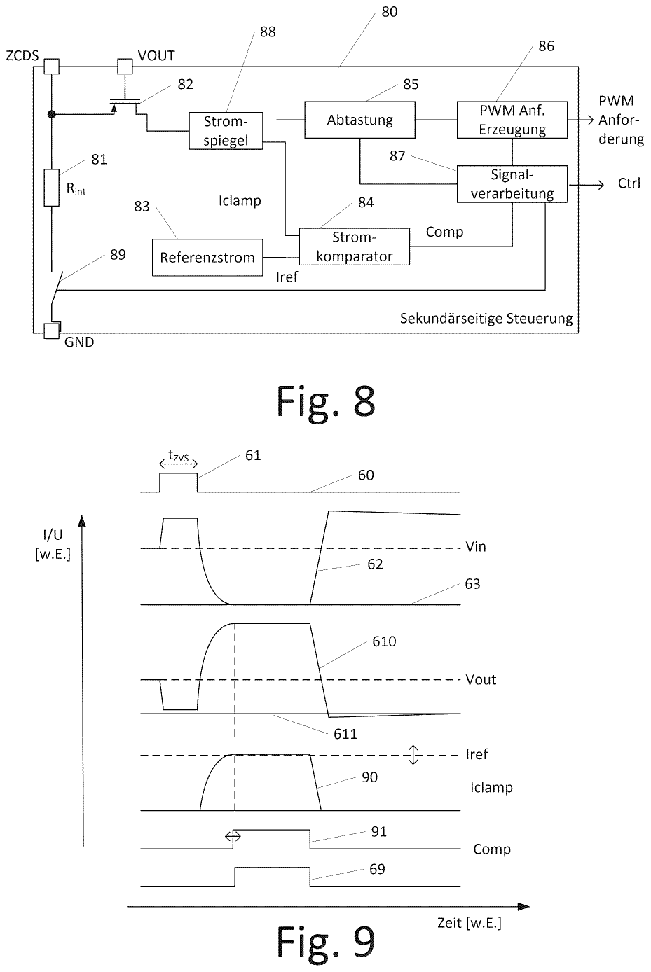

An explanation will first be given, with reference to FIG. 5, of the extent to which it may be helpful to control timing, namely timing with respect to the secondary-side switch in FIGS. 2 and 3 and for the measurement of the reflected input voltage in the case of FIG. 4, in power converters such as the power converter 10. For illustrative purposes, FIG. 5 shows a power converter 50, which represents an extension of the power converter 10 of FIG. 1. Elements of the power converter 50 corresponding to elements of the power converter 10 bear the same reference signs and are not explained again.

Compared to FIG. 1, in FIG. 5, the controller is illustrated as being divided into a secondary-side controller 52A, an isolation 52B and a primary-side controller 52C. The isolation 52B provides galvanic isolation between the secondary-side controller 52A and the primary-side controller 52C. The node 15 is connected to a corresponding input ZCDS of the secondary-side controller 52A via a resistor 54, also denoted R_{ZCDS}. The secondary-side controller 52A is thereby able to perform measurements, for example voltage measurements at the node 15 or measurements of a current flowing from the node 15. In addition to performing methods as explained with reference to FIGS. 2-4, such measurements are also used for the conventional control of power converters.

In order to control the power converter, the secondary-side controller 52A determines opening and closure of the primary-side switch 14 that is desired in order to achieve a desired output voltage (or output power, output current) and sends it in the form of a PWM request, that is to say in the form of a request for specific pulse-width-modulated driving of the primary-side switch 14, to the primary-side controller 52C across the isolation 52B. In order to determine the PWM request, the secondary-side controller may also obtain, in addition to a signal at the input ZCDS, a measure of the output voltage Vout at a feedback input FB (connection not shown in FIG. 5). For this purpose, the output voltage Vout may be measured for example by way of a resistive voltage divider. In addition, a terminal EA of the secondary-side controller 52B may also be connected to the terminal 19B via a filter circuit 54, 55, 56, wherein the terminal EA, as will be explained below with reference to FIG. 13, may be connected to an output of an error amplifier that compares the measure of the output voltage with a target voltage. This makes it possible to improve regulation of the output voltage. The primary-side controller 52C then drives the primary-side switch 14 accordingly. For control purposes, the primary-side controller may still measure a voltage minimum (valley detection) on a primary-side auxiliary winding (not shown). Other conventional measurements and input variables may also be used. Overall, apart from timing adjustments described below, control may take place in conventional fashion.

Compared to FIG. 1, parasitic capacitances 51A-51F are also shown. Such parasitic capacitances generally occur in electronic circuits.

The parasitic capacitances must be charged and discharged during switching operations, and therefore generally cause delays. Communication across the isolation 52B and the primary-side controller 52C also causes delays. The delays are indicated by arrows 53A, 53B, 53C in FIG. 5. The delays generally cause the above-described regulation of the closure and opening of the primary-side switch 14 to be delayed. Since these delays depend on the parasitic capacities and may fluctuate for example owing to manufacturing tolerances, the exact delays are generally unknown. It may therefore be quite difficult for example to adapt the timing of the closure of the switch 16 so as to cause zero-voltage switching of the primary-side switch 14 or to achieve synchronous rectification in a manner matching the closure of the primary-side switch 14, and/or to measure the reflected input voltage across the node 15, which is required for example for regulation purposes, at a suitable time.

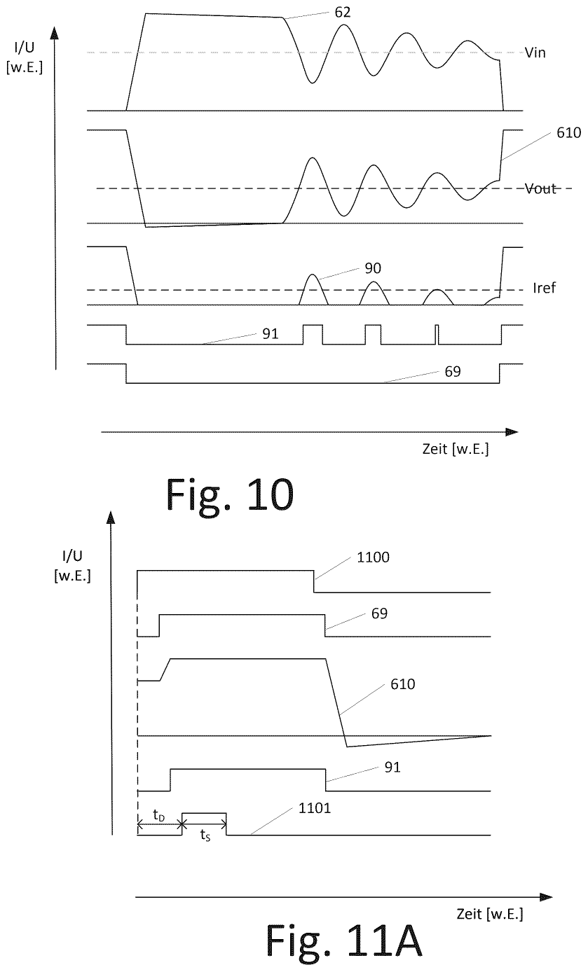

An explanation will now be given firstly of the method of FIG. 2 for setting a duration of closure of the secondary-side switch so as to achieve zero-voltage switching. FIGS. 6A-6C show exemplary signal diagrams to illustrate the significance of the duration of closure of the secondary-side switch for this purpose.

FIGS. 6A-6C show examples of signals for explaining the effect of the duration of closure of the secondary-side switch so as to cause zero-voltage switching on the primary side. For illustrative purposes, these signals are explained with reference to the power converter 50 of FIG. 5. The signals should in this case be understood to be schematic, and real signals may deviate from the waveforms illustrated. In addition, for the secondary-side switch 16 in FIGS. 6A-6C, only switching-on to cause the zero-voltage switching of the primary-side switch 14 is shown. The secondary-side switch 16, as explained, may additionally also fulfill a synchronous rectification functionality.

In FIGS. 6A-6C, a curve 60 indicates a control signal for the secondary-side switch 16 and a curve 69 indicates a control signal for the primary-side switch 14. When the respective signal is at a high level, the respective switch is closed, and when the respective control signal is at a low level, the respective switch is open.

A curve 62 indicates a voltage across the primary-side switch 14. With the ground of FIG. 5 as a reference point, this voltage is then a voltage at that terminal of the primary-side switch 14 that is connected to the primary-side winding 13A. In the case of an implementation of the primary-side switch 14 as a field-effect transistor, this may be a drain voltage of the primary-side switch 14. A line 63 indicates the zero line, and a dashed line denotes the input voltage Vin.

A curve 65 indicates a primary-side current through the primary winding 13A, and a dashed line 68 is a zero line for this. A curve 610 shows the profile of a voltage at the node 15, which corresponds to a drain voltage of the secondary-side switch 16 in the case of an implementation of the secondary-side switch 16 as a field-effect transistor, and a curve 611 shows a corresponding zero line.

FIG. 6A shows a case in which a duration of switch-on of the secondary-side switch 16 is at least approximately optimum. The duration for which the control signal according to curve 60 for switch-on is at the high level is also referred to as time ZVS pulse and is identified by the reference sign 61A in FIG. 6A. At the approximately optimum length of the ZVS pulse 61A, the voltage according to curve 62 is zero when the primary-side switch 14 is switched on (rising edge of curve 69), as indicated by a circle 64, and the primary-side current 65 is also zero, as indicated by a circle 67. It should be noted that this “zero” may be subject to a certain tolerance in each case. If for example input voltages of 100 V or more are able to be switched by the primary-side switch, a remaining voltage across the switch of a few volts may also still be understood to be zero-voltage switching within the scope of this application.

FIG. 6B shows a case in which a ZVS pulse 61B is longer than in FIG. 6A. As indicated by the circle 64, zero-voltage switching continues to be ensured here. However, as indicated by a circle 612, the current when the primary-side switch is switched on is other than zero, which may lead to undesired power losses.

FIG. 6C shows a case in which a ZVS pulse 61C is shorter than the ZVS pulse 61A of FIG. 6A. The primary-side switch 14 is switched on here, as indicated by the circle 67, at a primary-side current of zero. However, the voltage across the primary-side switch 14 according to curve 62 is other than zero, as indicated by an ellipse 613, which may on the one hand mean increased loading for the primary-side switch, and may on the other hand result in higher losses, since the energy that is still contained in a parasitic output capacitance of the primary-side switch 14 due to the remaining voltage is suddenly discharged. Both are likewise undesirable.

FIG. 7 illustrates the setting of a length t_{ZVS} of a ZVS pulse 61 based on the measurement from 20 of FIG. 2. FIG. 7 here shows a case in which the voltage difference is measured directly. FIG. 7 here shows the same curves as FIGS. 6A-6C, with the exception of the current 65.

The duration of the ZVS pulse 61 in FIG. 7, t_{ZVS}, is regulated based on a measurement that characterizes a difference between a first voltage at a first time 70 shortly before the closure of the primary-side switch 69, that is to say shortly before the rising edge of curve 69, and a voltage at a second time 71 while the primary-side switch is closed, that is to say while the control signal 69 is at the high level. In some exemplary embodiments, two voltage measurements may be used here and the difference may be calculated. As may be seen from curves 610 of FIGS. 6A and 6B in comparison to curve 610 of FIG. 6C, in zero-voltage switching, curve 610 substantially reaches its maximum, which corresponds to the reflected input voltage and the value while the primary-side switch is closed. The duration t_{ZVS} is therefore set such that the measure of the voltage difference indicates that the voltage at the time 70 is just below the voltage at the time 71 or just reaches it, for example that the voltage 70 is between 95% and 100% of the voltage at the second time 71. If, at the start of a setting process, the voltage at the first time 70 already corresponds to the second voltage at the second time 71, this may mean that the case of FIG. 6B of an excessively long ZVS pulse is present. In this case, t_{ZVS} may be shortened incrementally until the first voltage becomes just slightly smaller than the second voltage, which means that the case of FIG. 6A is reached.

Examples of the implementation of such voltage measurements will now be explained with reference to FIGS. 13 and 14.

FIG. 13 shows one embodiment of a secondary-side controller, which may serve for example as a secondary-side controller 52A of FIG. 5 or part thereof.

The secondary-side controller of FIG. 13 is connected by way of a terminal ZCDS to the node 15, for example as shown in FIG. 5 via the resistor 54. In addition, the secondary-side controller of FIG. 13 receives, at a terminal FB, information about the output voltage Vout, for example across a voltage divider, and is connected to the filter 54, 55, 56 of FIG. 5 via a terminal EA. Those parts of the secondary-side controller of FIG. 13 that are also used in conventional secondary-side controllers will now be discussed first of all.

The measure of the input voltage at the terminal FB is supplied to a first input of a differential amplifier 1314, and a reference voltage Vref corresponding to a target output voltage is supplied to the second input of the differential amplifier 1314. The differential amplifier 1314 is also referred to as error amplifier. An output of the differential amplifier 1314 is connected to the terminal EA. In addition, the output from the differential amplifier 1314 is supplied to a PWM controller 1312, which generates the PWM request (see FIG. 5) and sends it across a galvanic isolation 1313, for example the isolation 52B of FIG. 5, to a primary-side controller, such as the primary-side controller 52C of FIG. 5.

Based on the signal at the ZCDS terminal, the reflected input voltage is measured in a block 1310. This results in emulated current-mode control 1311 (CMC). Block 1311 here has an internal capacitor that is charged by the measured reflected input voltage from block 1310, resulting in a voltage ramp. The PWM controller 1312 has an internal comparator that compares the voltage at the terminal EA (which is essentially determined jointly by the output from the differential amplifier 1314) with this ramp and determines the PWM request therefrom. The timing of this measurement of the reflected input voltage in block 1310 may also be adjusted using the method of FIG. 4.

In addition, a peak/valley detection of oscillations at the ZCDS input may be carried out in a block 1309 (see FIG. 10 below as an example of oscillations). Peak values at the node 15 indicate valley values (minima) of a voltage across the primary-side switch 14. This information may then be used to control switch-on times of the primary-side switch 14 in order to implement what is known as valley switching. This may be advantageous in the case of low input voltages. The output of the peak-valley detection 1309 is likewise supplied to the PWM controller 1312 for this purpose.

In addition, the time of the peak value plus half the resonance period indicates a valley point, which may be used to initiate the ZVS pulse, that is to say to define the start of the ZVS pulse.

A zero-crossing detector 1306 detects a zero crossing when the voltage at the ZCDS terminal after switch-off of the primary-side switch 14 goes from positive values through zero, for example the zero crossing of curve 610 of FIG. 6A to 6C and 7 through the zero line 611. In addition, the rising zero crossing may also be detected. As a result, in accordance with the zero crossings across an SR pulse controller 1308, an SR gate driver 1305 for driving the secondary-side switch 16 via a terminal GDSR in order to achieve a synchronous rectification functionality is realized. The timing of the SR pulse controller 1308 may also be modified, in some embodiments, by the method of FIG. 3.

These measurements and control operations may be performed in conventional fashion.

In contrast to conventional secondary-side controllers, in the embodiment of FIG. 13, a voltage measurement block 1300 measures the voltage at the ZCDS terminal in order thereby to measure the voltage at the node 15. By way of example, the voltage measurement is activated periodically by a timer 1307. For the voltage measurement, the voltage at the ZCDS terminal may be stepped down, for example by way of a voltage divider, in order to provide a more suitable voltage range for the voltage measurement. While the voltage measurement is activated by a signal from the timer 1307, the measurement of the reflected input voltage 1310 is deactivated in this exemplary embodiment, since the abovementioned stepping down of the voltage may distort the measurement of the reflected input voltage.

A voltage while the primary-side switch is switched on is digitized in the illustrated exemplary embodiment by an analog-to-digital converter (ADC) 1301 and stored in a hardware register 1302. This corresponds to the reference value, for example the voltage at the time 71 of FIG. 7. When the measurement is carried out, this reference value is output as reference voltage V_{ZCDS_Ref}, for example, by a built-in digital-to-analog converter of the register 1302. This reference voltage is supplied to a first input of a comparator 1315. A second input of the comparator 1315 is connected directly to the voltage measurement block 1300. A signal ZVS-pulse off supplied to the timer 1307 ensures that the voltage measurement (apart from the measurement of the reference voltage) takes place in the abovementioned dead time.

The output from the comparator 1315 is thus a measurement that characterizes a difference between the voltage at the node 15 at a first time prior to closure of the primary-side switch 14 (in the dead time) and a second time at which the primary-side switch is closed. This measurement is then used in a block 1303 to adjust the duration of the ZVS pulse. A ZVS pulse controller 1304 then drives the SR gate driver 1305 so that it outputs a corresponding signal to the secondary-side switch 16 via the terminal GDSR.

In the exemplary embodiment of FIG. 13, the reflected input voltage is not available during the measurement of the voltages because the measurement is deactivated. The timer 1307 activates this measurement, but only sometimes, for example in every nth switching cycle, wherein n may be in the range of 10 to 100. It is then possible to use a previous value for switching cycles in which the reflected input voltage is not available for emulated current-mode control 1311.

FIG. 14 shows an alternative to the implementation of FIG. 13, in which no interruption of the measurement of the reflected input voltage is required. Here, the reference value V_{ZCDS_ref} is calculated as the sum of the output voltage Vₒᵤₜ, which is added to a block 1400, and the reflected input voltage from block 1310. The voltage measurement in block 1300 is then carried out at the full level at the ZCDS input and may be processed by an analog-to-digital converter 1401. As may be seen from FIG. 5, the reflected input voltage additionally corresponds to the voltage at the node 15 while the primary-side switch 14 is switched on.

The measurement in block 1300 here is in turn activated by the ZVS pulse controller 1304 (similarly to FIG. 13 by the timer), that is to say the ZVS pulse controller 1304 switches on the voltage measurement 1300 as soon as the ZVS pulse has ended.

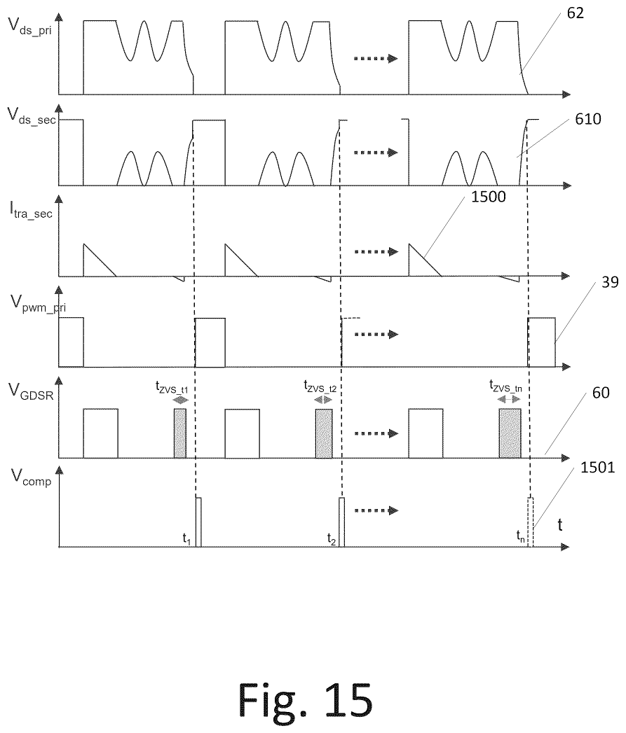

FIG. 15 illustrates the regulation of the duration of the ZVS pulse based on the output from the comparator 1315, wherein the curves, which have already been explained with reference to FIG. 6, bear the same reference signs. In curve 60, which corresponds here to the output voltage from the GDSR terminal of FIGS. 13 and 15, that is to say the control voltage for the secondary-side switch, the synchronous rectification control pulses are illustrated in addition to the ZVS pulses. In addition, in FIG. 15, a curve 1501 shows an output from the comparator 1315 of FIGS. 13 and 14, and a curve 1500 shows a secondary-side current through the secondary-side switch 16.

The regulation may then be as follows:

As described, the voltage at the input ZCDS during the dead time is compared with the reference voltage V_{ZCDS_ref}. If, at the end of the dead time, a 1, that is to say a high level, is output by the comparator 1315, the duration of the ZVS pulse t_{ZVS} is increased. This continues until the comparator output at the end of the dead time is 0. The duration may then be reduced again until a 1 is output again. This results in a duration in which the voltage at the end of the dead time is at or just below the reference value, which is desirable, as explained above. Step widths for the regulation may for example be of the order of magnitude of 25 ns, and a starting value may be half an oscillation period of the oscillation shown and discussed in more detail below with reference to FIG. 10.

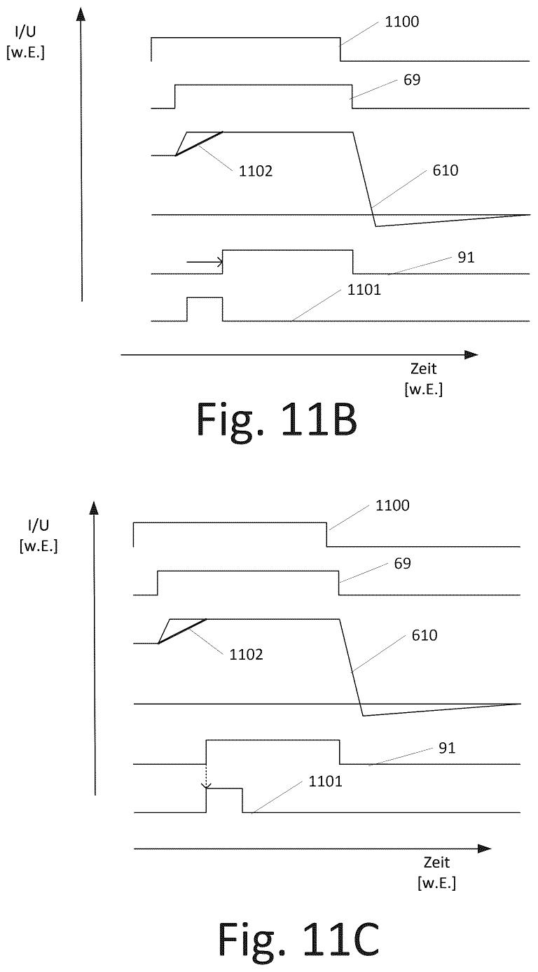

In addition to the direct measurement, as shown in FIGS. 13 and 14, it is also possible to achieve a measurement that characterizes the voltage difference using a current measurement. FIG. 8 shows a secondary-side controller 80, which is able to perform such a measurement and may serve for example as a secondary-side controller 52A of FIG. 5 or part thereof. The secondary-side controller of FIG. 8 may, like the secondary-side controllers of FIGS. 13 and 14, be implemented in various ways, for example as a digital circuit, in which current detection is carried out using analog-to-digital converters and the rest of the processing is carried out digitally, as an analog circuit, or as a combination of analog and digital circuits, referred to as mixed-signal circuits. Parts that relate to conventional aspects of the controller and have been explained with reference to FIGS. 13 and 14 are not illustrated in FIG. 8, but may likewise be implemented therein.

As illustrated in FIG. 8, the secondary-side controller 80 receives a current from the node 15 via the resistor 54 of FIG. 5 at the ZCDS input. A transistor 82 ensures that the voltage at the input ZCDS may never become greater than the output voltage Vout. This is achieved in that the transistor 82 causes a clamping current of the appropriate order of magnitude, as a result of which the input ZCDS is not at a higher voltage than the output voltage. This clamping current causes the voltage difference between the node 15 and the voltage at the input ZCDS to drop across the resistor 54. The circuit is therefore active only when the voltage at the node 15 is greater than the output voltage Vout. This current is mirrored, via a current mirror 88, to form a mirrored current Iclamp.

On the one hand, the mirrored current Iclamp is sampled by a sampling device 85. This sampling makes it possible for example to measure the reflected input voltage in order to compensate for the influence of the input voltage on power control in a block 86, which generates the control signal (PWM request) for the primary-side switch 14. Furthermore, the mirrored current is supplied to a current comparator 84, which compares the mirrored current Iclamp with a reference current Iref generated by a reference current generator 83. The result of the comparison is denoted Comp and is supplied to a signal processor 87. The signal Comp, or a time at which the signal Comp goes from low to high, likewise constitutes a measurement that identifies the discussed voltage difference, as explained below.

The signal processor 87 generates a control signal Ctrl for driving the secondary-side switch 16. In particular, the ZVS pulse may be generated here, wherein the length of the ZVS pulse is controlled based on the signal Comp.

Otherwise, a timing of the ZVS pulse, for example a start of the ZVS pulse, may be determined in conventional fashion by triggering the ZVS pulse shortly before the PWM request requests closure of the primary-side switch or, as explained with reference to FIGS. 13 and 14, on the basis of a peak-valley detection. Furthermore, the signal processor 87 may also drive the secondary-side switch in conventional fashion or, apart from the modifications explained below, in conventional fashion to achieve synchronous rectification.

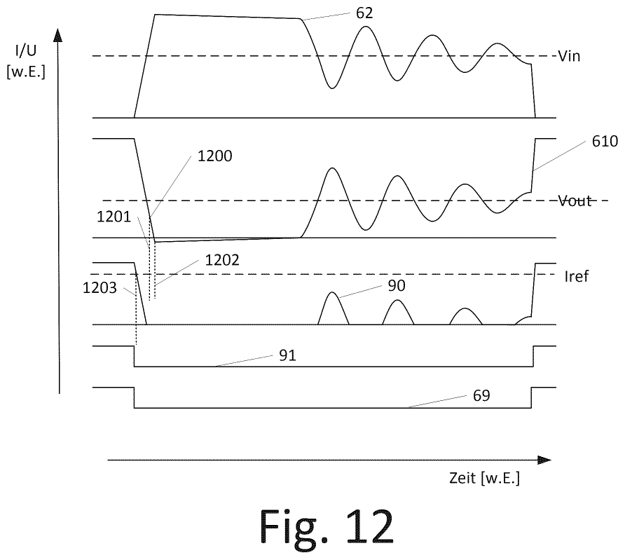

FIG. 9 explains such regulation. The curves 60 with the ZVS pulse 61, 62 and 610 to be regulated with respect to the duration t_{ZVS} are the same as in FIGS. 6A-6C and 7. The same applies to the control signal 69.

A curve 90 shows the current Iclamp supplied in the current comparator 84, and a dashed line shows the reference current Iref. Iref is set here such that it is just below a current that is present while the primary-side switch 14 is switched on. In other words, I_{ref} is set just below, for example between 90 and 98%, for example between 94% and 96%, a current caused by the second voltage at the second time 71 of FIG. 7. If the current I_{clamp} exceeds this threshold value I_{ref}, the comparator 85 switches and the signal 91 changes to a high state.

If this rising edge of the signal 91 is shortly before the rising edge of the signal 69, this means that the voltage at the node 15 shortly before this rising edge of the signal 69, for example at the first time 70 of FIG. 7, has almost reached the voltage at the second time, since the currents are then also almost equal. It is thus possible to set t_{ZVS} such that the switching of the signal Comp is shortly before the rising edge of the control signal 69. This also shows that the signal Comp likewise constitutes a measurement that characterizes the voltage difference.

This current measurement at the ZCDS input, as explained with reference to FIGS. 8 and 9, may, in some implementations and situations, be influenced by vibration effects. This is illustrated in FIG. 10, which shows the curves 62, 610, 90, 91 and 69 with vibrations that may occur after the primary-side switch has been switched off (transition of the signal 69 from high level to low level). If the current reference Iref is set to be relatively low, as illustrated in FIG. 10, this may result, as illustrated in FIG. 10, in accidental “tripping” of the current comparator, that is to say the signal Comp according to curve 91 goes to a high level at times at which it should ideally remain at the low level. This effect may also occur at higher values of Iref since, in an almost undamped case, the vibrations of curve 90 may also reach higher values, in particular almost the output level of the current prior to the switching operation.

To avoid such effects, it is possible to precondition a voltage level at the input ZCDS. For this purpose, in the exemplary embodiment of FIG. 8, provision is optionally made for a resistor 81 that is able to be grounded via a switch 89 and is connected to the ZCDS input by way of its other terminal. If a measurement is to be performed using the current comparator 84, the signal processor 87 drives the switch 89 so as to close. The resistor 81 then acts, together with the external resistor 54, as a voltage divider and sets the level at the ZCDS pin to a value that is able to prevent accidental tripping of the comparator, for example to a value just below the output voltage. In various implementations, this preconditioning is performed only at times when a measurement is to be carried out by the current comparator 84. This measurement may be performed at irregular or regular intervals to define t_{ZVS}, and in particular does not need to be performed in each switching cycle. In some implementations, for example, the measurements discussed here may be performed only after the voltage converter has been switched on or only at certain times or at certain time intervals.

The exemplary embodiment of FIG. 4 will be explained in more detail next, wherein a current measurement by way of a comparator is again used to measure the first voltage at 40 of FIG. 4.

FIG. 11A shows a conventional timing of the measurement of the reflected input voltage at the node 15. In addition to curves 69, 610 and 91 already discussed, a curve 1100 is also used to represent the PWM request as output by the secondary-side controller. As explained with reference to FIG. 5, delays occur, meaning that the actual switching of the primary-side switch according to curve 69 is delayed compared to the request according to curve 1100.

The reflected input voltage, that is to say essentially the voltage level at the node 15, has to be measured for control purposes after the primary-side switch has been switched on. Conventionally, the measurement is performed a delay time t_{D} after the rising edge of the signal 1100, wherein the time t_{D} is used to compensate for the delay between the signals 1100 and 69. The measurement then takes place within a measurement time t_{S}, which is symbolized by a high level of a curve 1101 in FIG. 11A.

In real systems, parasitic capacitances and other effects, for example caused by the transformer, may delay the increase in the voltage at the node 15, as illustrated by curve 610. This is symbolized in FIG. 11B by a slow increase 1102. In the case of conventional timing of the measurement of the reflected input voltage, it may be the case that the measurement takes place as indicated by curve 1101, while the voltage has not yet reached its steady-state value. This may distort the regulation of the power converter.

As may likewise be seen from FIG. 11B, the switching of the comparator, and thus the change of the signal 91 to a high level, is shifted to a later time as a result of this slower increase. In other words, the comparator output signal Comp according to curve 91 may give a measure as to when the voltage at the node 15 has at least approximately reached its maximum value (for example, at least 95% in the case of a corresponding current threshold I_{ref}).

Therefore, in some exemplary embodiments, as shown in FIG. 11C, the measurement of the reflected input voltage according to curve 1101 is started as soon as the comparator switches to a high level in accordance with curve 91. This means that the voltage at the node 15 has exceeded a predefined value.

In addition to using a current measurement, this may also be achieved using a direct measurement of the voltage at the node 15 until the voltage exceeds a predefined value.

Finally, the method of FIG. 3 will now be explained in more detail with reference to FIG. 12. FIG. 12 essentially corresponds to FIG. 10 with additional elements.

For synchronous rectification, the synchronous rectification switch is closed when the voltage at the node 15 has dropped substantially to zero (detected for example by the zero crossing detector 1306 of FIGS. 13 and 14). For this purpose, the voltage is conventionally compared to a threshold value, as explained above, and as soon as this threshold value is fallen below, the secondary-side switch 16 is switched on to achieve synchronous rectification. The threshold value, as indicated by a dashed line 1201 in FIG. 12 by way of example, may lie for example such that falling below the threshold value is detected at a time 1200, and then the secondary-side switch is switched on in accordance with the dashed line 1202. The output signal 91 from the comparator may provide additional information here. When the reference current Iref, which is illustrated here as being at a higher value than in FIG. 10, is fallen below, the signal 91 switches to a low level.

The switching of the comparator 91 provides an early indication that the primary-side switch has switched, which may be used to optimize the timing of the switch-on of the secondary-side switch 16 so as to achieve synchronous rectification. By way of example, an earlier switch-on may occur if a period between 1203, the time at which the comparator switches to a low output signal, and the dashed line 1201 exceeds a threshold value.

A few exemplary embodiments are defined through the following examples:

Example 1. A method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output, wherein the method comprises:
Obtaining a measurement that characterizes a difference between a voltage at a node between the terminal of the secondary-side winding and the secondary-side switch at a first time prior to closure of the primary-side switch and a second time at which the primary-side switch is closed, and
Adjusting the timing of the closure of the secondary-side switch based on the measurement.

Example 2. The method according to Example 1, wherein obtaining the measurement comprises measuring the voltage at the first time and measuring the voltage at the second time.

Example 3. The method according to Example 2, wherein the measurement of the voltage at the second time is stored in a register and the measurement of the voltage at the first time is carried out repeatedly in a period between an end of closure of the secondary-side switch (16), in order to enable zero-voltage switching of the primary-side switch (14), and a start of closure of the secondary-side switch (16), in order to implement a synchronous rectification functionality.

Example 4. The method according to Example 2 or 3, wherein a measurement of a reflected input voltage is deactivated during the measurement of the voltage.

Example 5. The method according to Example 2, wherein the measurement of the first voltage is carried out based on a measurement of an output voltage from the power converter and a reflected input voltage of the power converter.

Example 6. The method according to Example 1, wherein obtaining the measurement comprises comparing a current from the node with a reference current.

Example 7. The method according to Example 6, wherein the reference current corresponds to the current from the node at the second time.

Example 8.The method according to Example 6 or 7, furthermore comprising determining the reference current by measuring the current from the node while the primary-side switch is closed, and using the measured current as the reference current in a subsequent switching cycle of the power converter.

Example 9. The method according to one of Examples 6-8, wherein adjusting the timing comprises adjusting a time of closure of the secondary-side switch in order to implement a synchronous rectification functionality based on a time at which the current drops below the reference current.

Example 10. The method according to one of Examples 1 to 9, wherein adjusting the timing comprises adjusting a duration for which the secondary-side switch is closed in order to transmit energy for zero-voltage switching of the primary-side switch.

Example 11. The method according to Example 10, wherein adjusting the duration comprises adjusting the duration until the measurement indicates that the voltage at the first time is equal to the voltage at the second time, with a predefined tolerance.

Example 12. The method according to one of Examples 1 to 11, wherein adjusting the timing comprises adjusting a time at which the secondary-side switch is closed in order to implement a synchronous rectification functionality.

Example 13. A method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output, wherein the method comprises:
Measuring a current from a node between the terminal of the secondary-side winding and the secondary-side switch,
Adjusting a time of closure of the secondary-side switch in order to implement a synchronous rectification functionality based on the measurement.

Example 14. The method according to Example 13, wherein comprises adjusting the time based on the detection of a drop in the current after opening of the primary-side switch.

Example 15. A method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output, wherein the method comprises:
Obtaining a first measurement that characterizes a voltage at a node between the terminal of the secondary-side winding and the secondary-side switch, and
Performing a second measurement of a reflected input voltage on the secondary side while the measurement indicates that the voltage is above a threshold value.

Example 16. The method according to Example 15, wherein the second measurement is started as soon as the first measurement indicates that the voltage is above the threshold value.

Example 17. The method according to Example 16, wherein obtaining the first measurement comprises comparing a current from the node with a reference current, wherein the measurement is started as soon as the current is above the reference current.

Example 18. A controller for a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output,
wherein the controller comprises one or more components configured to control the power converter so as to perform the method according to one of Examples 1 to 17.

Example 19. A power converter, comprising: a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output, and the controller according to Example 18.

Although specific exemplary embodiments have been illustrated and described in this description, those skilled in the art will recognize that a multiplicity of alternative and/or equivalent implementations may be selected as a substitute for the specific exemplary embodiments that are disclosed and described in this description, without departing from the scope of the disclosed invention. This application is intended to cover all adaptations or variations of the specific exemplary embodiments that are discussed here. It is therefore intended for this invention to be restricted only by the claims and the equivalents of the claims.

1. A method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output, a node connecting the terminal of the secondary-side winding to the secondary-side switch, wherein the method comprises:
obtaining a measurement indicating a difference between a first voltage and a second voltage, the first voltage measured at the node at a first time prior to closure of the primary-side switch, the second voltage measured at the node at a second time during which the primary-side switch is closed; and
adjusting the timing of the closure of the secondary-side switch based on the measurement.

2. The method as in claim 1, wherein obtaining the measurement comprises measuring the first voltage at the first time and measuring the second voltage at the second time.

3. The method as in claim 2, wherein the measurement of the second voltage at the second time is stored in a register and the measurement of the first voltage at the first time is carried out repeatedly in a period between an end of closure of the secondary-side switch in order to enable zero-voltage switching of the primary-side switch, and a start of closure of the secondary-side switch, in order to implement a synchronous rectification functionality.

4. The method as in claim 2, wherein a measurement of a reflected input voltage is deactivated during the measurement of the first voltage and the second voltage.

5. The method as in claim 2, wherein the measurement of the first voltage is carried out based on a measurement of an output voltage from the power converter and a reflected input voltage of the power converter.

6. The method as in claim 1, wherein obtaining the measurement comprises comparing a current from the node with a reference current.

7. The method as in claim 6, wherein the reference current corresponds to the current from the node at the second time.

8. The method as in claim 6, further comprising determining the reference current by measuring the current from the node while the primary-side switch is closed, and using the measured current as the reference current in a subsequent switching cycle of the power converter.

9. The method as in claim 6, wherein adjusting the timing comprises adjusting a time of closure of the secondary-side switch in order to implement a synchronous rectification functionality based on a time at which the current drops below the reference current.

10. The method as in claim 1, wherein adjusting the timing comprises adjusting a duration for which the secondary-side switch is closed in order to transmit energy for zero-voltage switching of the primary-side switch.

11. The method as in claim 10, wherein adjusting the duration comprises adjusting the duration until the measurement indicates that the first voltage at the first time is equal to the second voltage at the second time, with a predefined tolerance.

12. The method as in claim 11, wherein adjusting the timing comprises adjusting a time at which the secondary-side switch is closed in order to implement a synchronous rectification functionality.

13. A method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output, a node connecting the terminal of the secondary-side winding to the secondary-side switch, wherein the method comprises:
measuring a current from through the node between the terminal of the secondary-side winding and the secondary-side switch,
adjusting a time of closure of the secondary-side switch in order to implement a synchronous rectification functionality based on the measured current.

14. The method as in claim 13, further comprising: adjusting the time based on the detection of a drop in a magnitude of the current after opening of the primary-side switch.

15. A method for operating a power converter, wherein the power converter comprises a primary side coupled to an input, said primary side comprising a primary-side switch coupled to a primary-side winding of a transformer, and a secondary side coupled to an output, said secondary side comprising a secondary-side switch coupled between a terminal of a secondary-side winding of the transformer and a terminal of the output, a node connecting the terminal of the secondary-side winding to the secondary-side switch, wherein the method comprises:
obtaining a first measurement indicating a voltage at the node between the terminal of the secondary-side winding and the secondary-side switch, and
performing a second measurement of a reflected input voltage on the secondary side while the voltage at the node is above a threshold value.

16. The method as in claim 15, wherein the second measurement is started as soon as the first measurement indicates that the voltage is above the threshold value.

17. The method as in claim 16, wherein obtaining the first measurement comprises comparing a current through the node with a reference current, wherein the measurement is started as soon as the current is above the reference current.

18. A controller operative to control the power converter and the method as in claim 1.
